(19) United States
(12) Patent Application Publication
(10) Pub. No.: US 2005/0049021 A1
(43) Pub. Date: Mar. 3, 2005

(54) Device and method for redirecting a wireless communication link based on location

(76) Inventors: Bogdan R. Nedelcu, N. Barrington, IL (US); Christopher J. Lieggi, Addison, IL (US)

Correspondence Address: DONNA & WILLIAM CONN, 20306 SEABROOK DRIVE, MONTGOMERY VILLAGE, MD, 20886, US

(21) Appl. No.: 10/918,881

(22) Filed: Aug. 16, 2004

Related U.S. Application Data
(60) Provisional application No. 60/498,388, filed on Aug. 26, 2003.

(51) Int. Cl. H04L 12/66

(52) U.S. Cl. 455/575.9

(57) ABSTRACT

A wireless communication device (22) in a vehicle (26) for maintaining a communication link according to either a first wireless communication protocol or a second wireless communication protocol. The device comprises a first network access device (42), a second network access device (44), a positioning unit (66), a memory (64), and a controller (56). The first network access device (42) operates according to a first wireless communication protocol. The second network access device (44) operates according to a second wireless communication protocol. The positioning device (66) is used for determining a location of the vehicle (26). The memory (64) stores a database of geographic coverage areas for maintaining the communication link according to the first wireless communication protocol. The controller (56) switches or otherwise redirects a communication link from operating according to the second wireless communication protocol to operating according to the first wireless communication protocol when the location of the vehicle (26) falls within the geographic coverage area of the first wireless communication protocol.

The present application claims priority from provisional application, Ser. No. 60/498,388, entitled “Device and Method for Redirecting a Wireless Communication Link Based on Location,” filed Aug. 26, 2003, which is commonly owned and incorporated herein by reference in its entirety.

### FIELD OF THE INVENTION

This invention in general relates to a device and method for redirecting a wireless communication link by a wireless communication device having more than one wireless transceiver and, more particularly, to a device and method that uses location based information to redirect the wireless communication link.

### BACKGROUND OF THE INVENTION

There is an ever-increasing demand for wireless communication and convenience. Wireless subscribers desire to have access to information at any time and any place. Wireless subscribers also desire to be able to control other mechanical and electronic devices through one wireless device in an efficient and cost-effective manner. One of the fastest growing markets for providing wireless services is known as “Telematics” and entails delivering a wide spectrum of information and services via wireless links to vehicle-based subscribers. In addition to hands-free voice calls, the type of information and services anticipated for Telematics include emergency services such as collision notification and roadside assistance. Telematics may also include other services such as navigation, route guidance, remote-door unlocking, traffic information, weather information, and points of interest.

A wireless communication device, such as the ones anticipated for Telematics applications, may be equipped with multiple network access devices, each operating according to a different wireless communication protocol. One network access device is typically programmed as a primary transceiver so that the system will use a “preferred” wireless communication protocol for a wireless communication link. However, the vehicle may not be in an area of coverage of the preferred wireless communication protocol. Accordingly, the system would operate according to a secondary wireless communication protocol using a second network access device. A problem may exist if there is a desire to switch back to the preferred network access device if the vehicle reenters a coverage area. For instance, for RF reasons, it may not be possible for both network access devices to operate simultaneously if both network access devices operate at similar frequencies. Thus, the system would be stuck operating according to a secondary wireless communication protocol until the call ends.

Accordingly, there is a need to provide an improved system and method for redirecting wireless communication links for calls having more than one wireless network access device. It is, therefore, desirable to provide an improved system and method to overcome or minimize most, if not all, of the preceding problems.

### BRIEF DESCRIPTION OF THE DRAWINGS

FIG. 1 is a top-level block diagram of one embodiment of a system of the present invention having a wireless communication system in a vehicle and a remote service center;

FIG. 2 is a block diagram of one embodiment of a wireless communication system in a vehicle for the system in FIG. 1;

FIG. 3 is a flow diagram illustrating one embodiment a method in a wireless communication device for redirecting a wireless communication link from a secondary communication protocol to a primary communication protocol;

FIG. 4 is a table illustrating one embodiment of a database having information regarding the geographic coverage areas for communicating with base stations that operate according to a primary wireless communication protocol;

FIG. 5 is a schematic representation of one embodiment of geographic coverage areas for communicating with base stations that operate according to a primary wireless communication protocol;

FIG. 6 is a table illustrating another embodiment of a database having information regarding the geographic coverage areas for communicating with base stations that operate according to a first wireless communication protocol;

FIG. 7 is a schematic representation of another embodiment of geographic coverage areas for communicating with base stations that operate according to a first wireless communication protocol; and

FIG. 8 is a table illustrating another embodiment of a database having information regarding the geographic coverage areas for communicating with base stations that operate according to a first wireless communication protocol.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is a device and method for redirecting a wireless communication link for a wireless communication device in a vehicle having more than one wireless network access device. The device and method allows a device to redirect a wireless communication link from operating according to a secondary wireless communication protocol to a preferred wireless communication protocol. This is especially important where the two network access devices cannot operate simultaneously and there is a desire to use the preferred wireless protocol.

To this end, in one embodiment there is a wireless communication device in a vehicle for maintaining a communication link according to either a first wireless communication protocol or a second wireless communication protocol. The device comprises a first network access device, a second network access device, a positioning unit, a memory, and a controller. The first network access device operates according to a first wireless communication protocol. The second network access device operates according to a second wireless communication protocol. The positioning device is used for determining a location of the vehicle. The memory stores a database of geographic coverage areas for maintaining the communication link according to the first wireless communication protocol. The controller switches a communication link from operating according to the second wireless communication protocol to operating according to the first wireless communication protocol when the location of the vehicle falls within the geographic coverage area of the first wireless communication protocol. The device works well where both protocols operate in similar frequencies such a Global System for Mobile Communications (GSM) protocol and an Advanced Mobile Phone System (AMPS) that are 850 MHz capable.

In another embodiment, the wireless communication device comprises a first and second transceiver, a positioning unit, a memory, and a means for switching from the second transceiver to the first transceiver. The first transceiver operates according to a first wireless communication protocol and the second transceiver operates according to a second wireless communication protocol. The positioning unit is used to determine the location of the wireless communication device. The memory stores information regarding the geographic coverage areas for communicating with remote base stations that operate according to the first wireless communication protocol. The means for switching from the second transceiver to the first transceiver may occur when the location of the wireless communication device is within the geographic coverage area for the first wireless communication protocol.

There is also a method in a wireless communication device of a vehicle. The wireless communication device has a first network access device and a second network access device. The first network access device operates according to a first wireless communication protocol. The second network access device operates according to a second wireless communication protocol. The method includes the steps of: determining whether the wireless communication device is communicating through the second network access device; determining the location of the vehicle when it is determined that the wireless communication device is communicating through the second network access device; accessing a memory in the wireless communication device to obtain information regarding geographic coverage areas for communicating with remote base stations that operate according to the first wireless communication protocol; and redirecting a communication from the second network access device to the first network access device based on the location of the vehicle and based on the information regarding the geographic coverage areas for communicating with the remote base stations that operate according to the first wireless communication protocol.

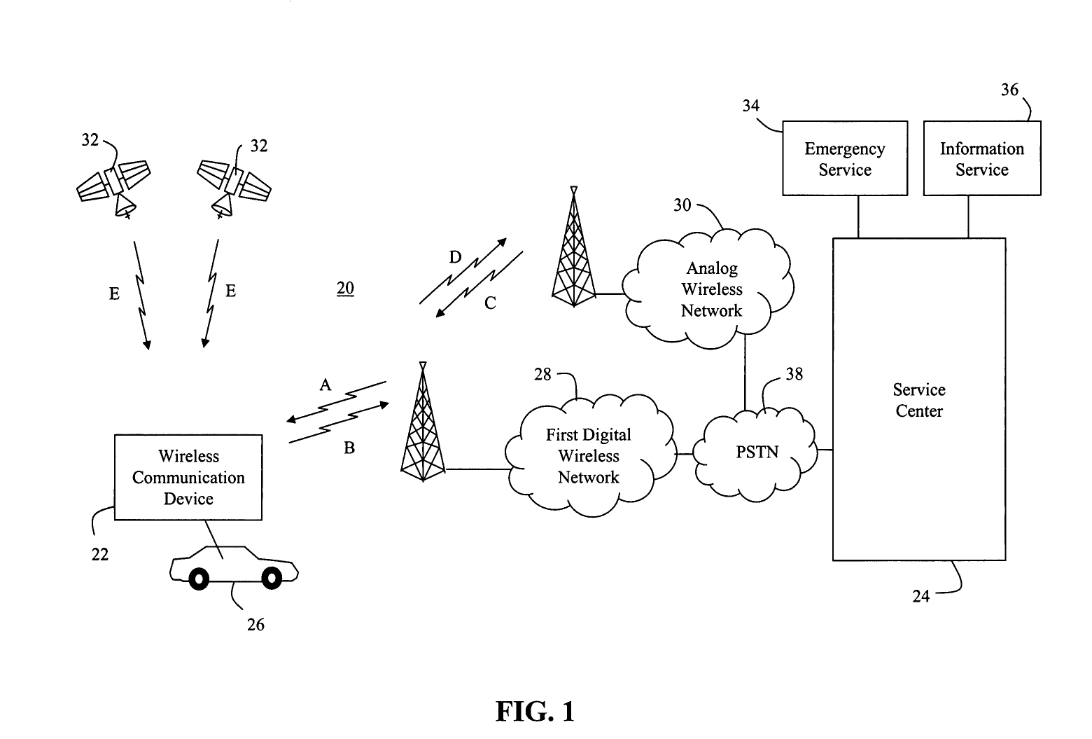

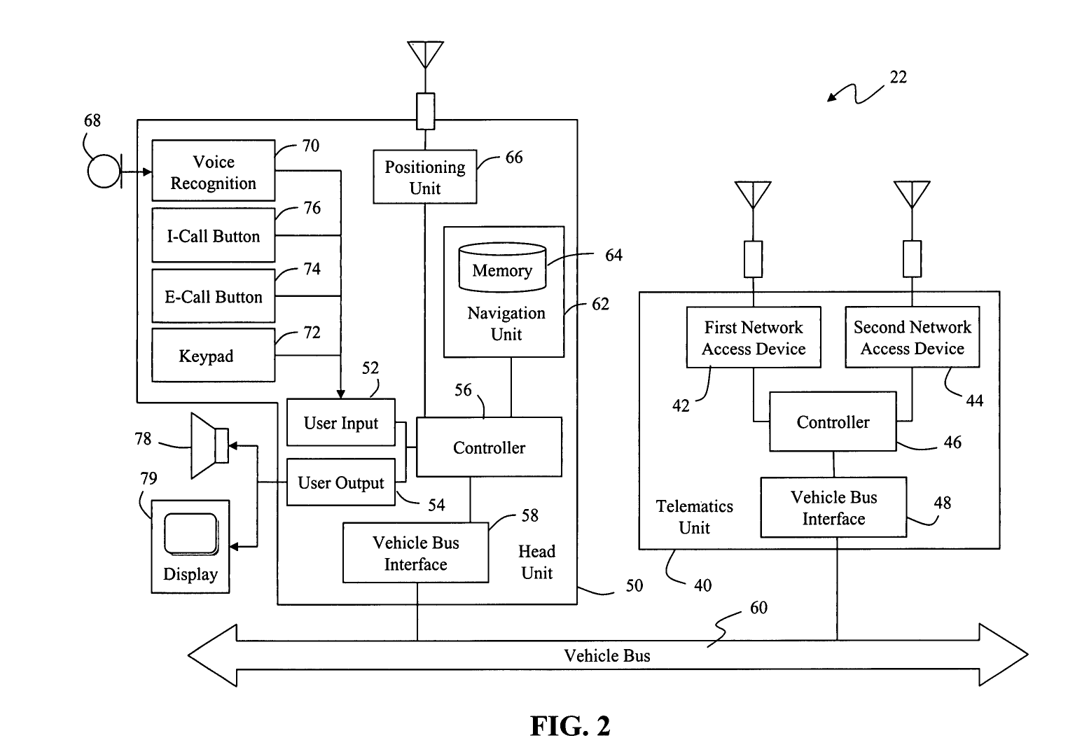

For the purposes of illustration and description, an example of a wireless communication device in a vehicle will be used. To that end, turning to the drawings, FIG. 1 illustrates a top-level block diagram of a communication system 20 for the present invention. Generally, the communication system 20 may include a wireless communication device 22, wireless networks 28, 30, public land networks 38, and a service center 24. In one embodiment, the wireless communication device 22 is incorporated into a vehicle 26. Although only one wireless communication device 22 and service center 24 are shown, the invention can include any number of these elements interoperating with each other. The components and functions of the wireless communication device 22 and service center 24 are described further below in relation to FIGS. 2-8 for the purpose of illustrating the present invention.

Referring initially to FIG. 1, in the communication system 20, the wireless communication device 22 may attempt to establish a wireless communication link with the service center 24, or other destination, for the purpose of placing a voice call or for the purpose of transmitting a data message. The wireless communication links are illustrated in FIG. 1 by communication arrows A-D. The wireless communication links A-D may be divided into individual sets (A-B, C-D) for different types of wireless communication protocols. For instance, the wireless communication device 22 may include a first wireless network access device or transceiver that is capable of establishing a wireless communication link A-B through a preferred digital wireless network 28. This may include a network access device that operates according to a wireless communication protocol such as a Global System for Mobile Communications (GSM) protocol, a Code Division Multiple Access (CDMA) protocol, or a Time Division Multiple Access (TDMA) protocol. The wireless communication device 22 may also include wireless network access devices or transceivers that are capable of establishing wireless communication links C-D through a secondary wireless network 30. This may include a network access device that operates according to a wireless communication protocol such as the Advanced Mobile Phone System (AMPS). The wireless network 28, 30 may then communicate with other communications systems, such as a public switched telephone network (PSTN) 38, to interface with a destination like a service center 24.

The above described wireless communication protocols are merely representative of existing protocols that could be used in the present invention. A wireless communication link by the wireless communication device 22 with the service center 24 for the purpose of placing a call will now be described generally although a more detailed description is provided after the general discussion.

Referring to FIGS. 1 and 2, in one embodiment, the wireless communication device 22 may comprise a Telematics unit 40 and a head unit 50. The Telematics unit 40 may include a first network access device 42, a second network access device 44, a controller 46, and a vehicle bus interface 48. The head unit 50 may further include a user input means 52, a user output means 54, a controller 56, a vehicle bus interface 58, a navigation unit 62 with memory 64, and a positioning unit 66. The Telematics unit 40 and the head unit 50 may communicate with each other via a vehicle bus 60 through the vehicle bus interfaces 48, 58. One suitable vehicle bus 60 is a Controller Area Network (CAN). CAN is a serial bus system especially suited to interconnect smart devices and allows for the broadcasting of messages. There, each controller 46, 56 can be a sender (a master) or a receiver (a slave) and each is interconnected through the vehicle bus 60. A separate bus microcontroller (not shown) directly controls its own resources, and indirectly controls resources of other microcontrollers on the bus. The vehicle bus 60 may further be connected to various subsystems of the vehicle 26 for remote control from the service center 24. For instance, one of the Telematics applications may permit remote unlocking of doors.

In general, the wireless communication device 22 attempts to place a call to the service center 24 or other destination using either the first network access device 42 or the second network access device 44. Each network access device 42, 44 operates according to a different wireless communication protocol technology. It should be understood that one of the network access devices is typically selected as the preferred network access device 42 for any wireless communication links with the service center 24. The preferred network access device 42 may be initially attempted but if the vehicle is not within the geographic coverage area of the associated wireless communication protocol, the secondary network access device 44 may need to be used. If the secondary network access device 44 is used, as will be explained in more detail below, the present invention includes systems and methods of redirecting the wireless communication link back to the primary network access device 42. This will generally depend on the location of the wireless communication device 22 (determined by the positioning unit 66) and the geographic coverage area for fixed base stations (stored in memory 64) that operate according to the preferred wireless communication protocol.

Depending on the particular implementation, the first and second network access devices 42, 44 may be an integral part of the vehicle 26. Alternatively, one of the first or second network access devices 42, 44 may be separate component such as a portable cellular or Personal Communication System (PCS), a pager, or a hand-held computing device such as a personal digital assistant (PDA) that is docked or otherwise connected to a wireless communication device 22 in the vehicle 26.

The first and second network access devices 42, 44 include a transmitter function to transmit voice and data messages via a wireless communication protocol such as AMPS, CDMA, GSM or TDMA. As explained above, the transmitter may be configured to establish wireless communication links for voice calls and/or data messages. If the wireless communication device 22 is configured to send data messages over an analog protocol, one of the network access devices will need a data modem.

The first and second network access devices 42, 44 also include a receiver function to receive and decode voice calls and data messages from the service center 24 or other sources. The receiver may be configured to receive data and voice calls through a wireless communication protocol such as CDMA, GSM, TDMA, or AMPS.

The wireless communication device 22 may attempt to establish a wireless communication link for a call in a number of ways. For instance, the wireless communication device 22 may attempt to establish a wireless communication link in response to one of the user input means 52. One type of user input means 52 may include a voice command received through the microphone 68 that is processed by a voice recognition system 70. Another type of user input means 52 may include a keypad 72 or a application-specific buttons (such as an emergency call (E-Call) button 74 or an information call (I-Call) button 76) that would indicate a user's desire to place a voice call or data message to a particular destination. Additionally, a software application monitoring certain vehicle sensors (such as an airbag deployment sensor) may automatically initiate the transmittal of a data message to the service center 24 upon the occurrence of an event (such as the deployment of the airbag).

In response to receiving the voice call or data message from the wireless communication device 22, the service center 24 or other destination may further act in a number of ways depending on the type of voice call or data contained in the message. For example, if the voice call or data message indicates that the user has an emergency (such as an airbag deployment), the service center 24 may contact an emergency service 34with the location of the vehicle 26. The emergency service 34 may then send the police, fire brigade, or medical support as needed to the location. If the data contained in the message indicates that the user is simply in need of information (such as navigation, route-guidance, or traffic services), the service center 24 may contact an information service 36 to obtain information related to the request. The service center 24 could then use the obtained information to process the requested service. If the voice call or data message indicates that the user is in need of vehicle service (such as a flat tire), the service center 24 may contact a vehicle service with the location of the vehicle 26. The vehicle service may then send a tow truck or automobile mechanic as needed to the location.

The user output means 54 may include a variety of options such as a speaker 78 or display screen 79. Other user output means 54 may be included depending on the implementation such as warning indicators or alarms. The output means 54 may further provide the user with the ability to receive information from the service center 24 relating to a service request.

As mentioned above, the present invention is directed to switching a wireless communication link from a secondary network access device 44 to a primary network access device 42. For instance, a user may need to establish a wireless communication link through a secondary network access device 44 because the vehicle 26 is not within the geographic coverage area for communicating with the primary network access device 42. When the vehicle 26 subsequently enters the geographic coverage area supported by the protocol for the primary network access device 42, there is a need to switch the wireless communication link from the secondary network access device 44 to the primary network access device 42. In one embodiment, generally, the controller 46 in the Telematics unit 40 will send a message, via the vehicle bus 60, to the controller 56 in the head unit 50 when the vehicle 26 is communicating through the secondary network access device 44 or otherwise outside of the geographic coverage area of the first (or preferred) wireless communication protocol. Once the head unit 50 receives the message from the Telematics unit 40, the controller 56 in the head unit 50 will then start a monitoring process based on data from the positioning unit 66 (the location of the vehicle 26) and the memory 64 in the navigation unit 62 (the geographic coverage area for the preferred wireless communication protocol). The head unit 50 determines when coverage is available for the preferred wireless communication protocol. When the head unit 50 determines that coverage is available for the preferred wireless communication protocol, the controller 56 of the head unit 50 will then send a message, via the vehicle bus 60, to the controller 46 in the Telematics unit 40 to instruct it to switch the communication link from the operating through the second network access device 44 to the first network access device 42.

In one embodiment, the controller 56 in the head unit 50 receives position data from the positioning unit 66. The position data received from the positioning unit 66 relates to a current geographic location of the vehicle 26. The location of the vehicle 26 is important in the present invention for the redirecting of a wireless communication link from the second network access device 44 to the first network access device 42. The location of the vehicle 26 may also be important in several wireless applications. For example, when an emergency exists, a message to the service center 24 should contain location data of the vehicle 26 in addition to other data about the emergency. Additionally, when a user requests navigation services, the message may contain data on the current location of the vehicle 26 to assist in generating a navigation route to a desired location.

In one embodiment, the positioning unit 66 may include a global positioning system (GPS) receiver. A plurality of satellites 60 that orbit the earth transmit radio signals E to the GPS receiver. The radio signals E are pseudo-random signals that contain information modulated by a pseudo-random code. The GPS receiver in the positioning unit 66 is able to receive and process the satellite radio signals to calculate position and time. Conventional GPS receivers need to track at least four satellites of the GPS constellation in order to compute a GPS receiver's position and time. An almanac is stored in the positioning unit 66 to help identify visible satellites and to track satellite orbits. Locally generated pseudorandom noise codes are generated within the positioning unit 66 and compared to the received satellite signals. From the compared signals, the positioning unit 66 generates measurement data that reflects travel times of the received satellite signals. Knowing the travel times of the satellite signals allows the positioning unit 66 to compute distances between each satellite and the positioning unit 66. The positioning unit 66 may then compute a position solution that can be reported to the controller 56.

The controller 56 in the head unit 50 also accesses memory 64 in the navigation unit 62 to obtain information from a database containing the geographic coverage areas for communicating with fixed base stations that operate according to at least one of the wireless communication protocols for the first network access device 42 or the second network access device 44. Depending on the location of the vehicle 26 and the information contained in the database of geographic coverage areas, the controller 56 then determines whether to redirect a voice communication link from the second network access device 44 to the first network access device 42. In one embodiment, the controller 56 receives the position information and compares the position information with the database of geographic coverage areas. In a further embodiment, the controller 56 may further use position and the direction of the vehicle 26 and attempt to determine whether continuous coverage will exist for a period of time. This avoids any ping-pong effects that may occur if there are small pockets of coverage areas.

The format of suitable databases may be configured so they are dynamic and capable of being updated by the service center 24. For example, the database may contain a version number that can be used to determine if the database is up to date. The version number in the wireless communication device 22 could be queried by the service center 24 to see if the database in the device is current. If the unit version number does not match the database repository version number, then the database in the wireless communication device 22 would be out of date and an updating process could be executed. Alternatively, the database may be loaded manually through CDs or the like.

In one embodiment, the entire database may be updated. A database repository in the service center 24 would instruct the unit to delete the entire database stored in the wireless communication device 22. Thereafter, a new database would be sent to the wireless communication device 22 by a database repository in the service center 24. This type of procedure could be used when there are major changes between the database revisions and the database in the device. In another embodiment, the updating process only includes an incremental change. For instance, when the database has not changed much from a previous version, it will be easier for the database repository in the service center 24 to direct the wireless communication device 22 to make incremental changes to its stored database instead of replacing the entire database. The database repository in the service center 24 could tell the device to add an entry to a field in the database and the pertinent information for an entry in that field. The database repository in the service center 24 could also tell the device to delete an entry from the database by providing the field and the pertinent information for the entry to be deleted. Additionally, the database repository in the service center 24 could tell the wireless communication device 22 to change the version number for its database.

After accessing the database and determining that a wireless communication link should be redirected to a primary or first network access device 42, the controller 56 in the head unit 50 may also be configured to send a message to the Telematics unit 40, via the vehicle bus 60, so that it can establish a wireless communication link through the first network access device 42. For voice calls, there are a number of ways of accomplishing this but, functionally, in one embodiment, the controller 46 may route a call through the selected first network access device 42 through switches or other control means.

The controllers 46, 56 for the present invention may includes a digital signal processor (DSP) controller with memory. As described in more detail below, the controllers 46, 56 of the present invention preferably executes a number of functional steps. These functional steps may be microcoded signal processing steps that are programmed as operating instructions in the controllers 46, 56. The operating instructions may be stored in a computer-readable medium in the controllers 46, 56. The flow diagrams described below are merely representative of some of the possible embodiments of the present invention.

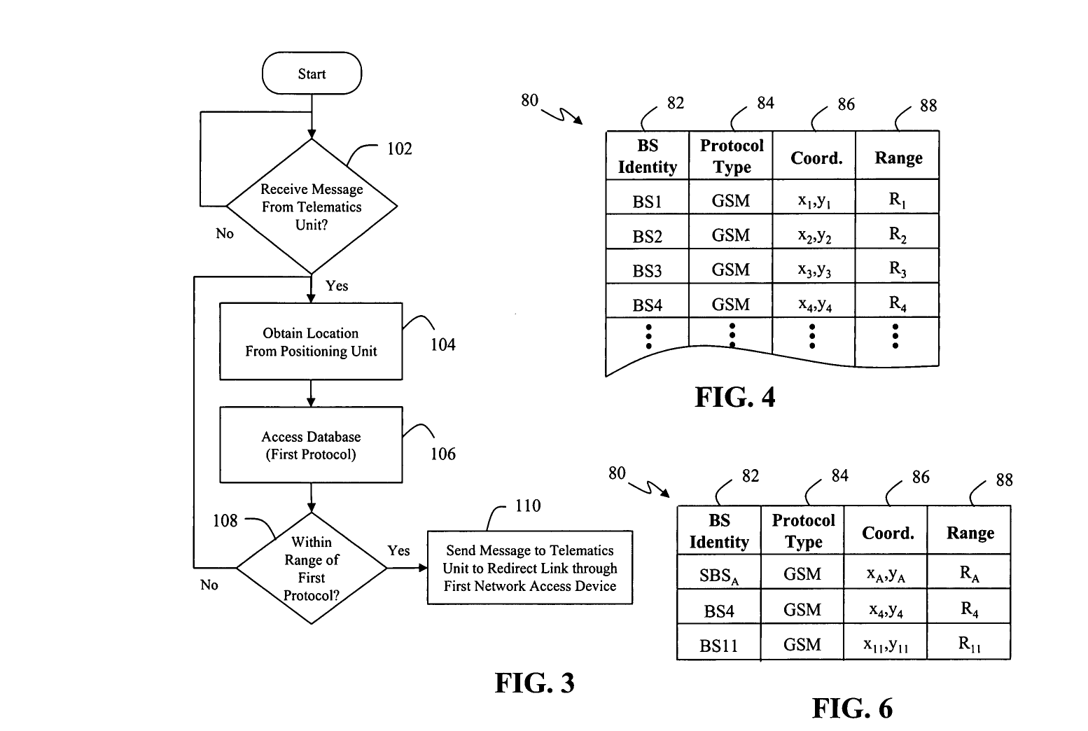

In particular, FIG. 3 shows a flow diagram illustrating one embodiment of a method that may be performed by the controller 56 in the head unit 50 of the wireless communication device 22. In one embodiment, the method includes a decision block 102 that determines whether a message has been received from the Telematics unit 40 or otherwise determines whether the Telematics unit 40 is communicating through the second network access device 44. The message may include a notification that the Telematics unit 40 is using the secondary network access device 44 to maintain a wireless communication link with the remote service center 24. If it is determined that a message has been received, then the process continues to blocks 104 and 106.

At process block 104, the controller 56 obtains the location of the vehicle 26 from the positioning unit 66. At process block 106, the controller 26 accesses a database stored in memory 64. This database should include information regarding the geographic coverage areas for at least one of the wireless communication protocols supported by the network access devices, such as the first network access device 42.

For example, FIG. 4 illustrates one embodiment of a database 80 that contains information regarding the geographic coverage areas for at least one wireless communication protocol (GSM). In particular, this database includes information regarding a plurality of cellular base stations that operate according to the wireless communication protocol. The database 80 may have a variety of data fields such as a base station identity field 82 that may identify a particular base station, a wireless protocol type field 84 that may identify the type of protocol of the base station, a coordinate field 86 that may identify the longitude and latitude of the base station, and a range field 88 that may identify a coverage radius of the base station.

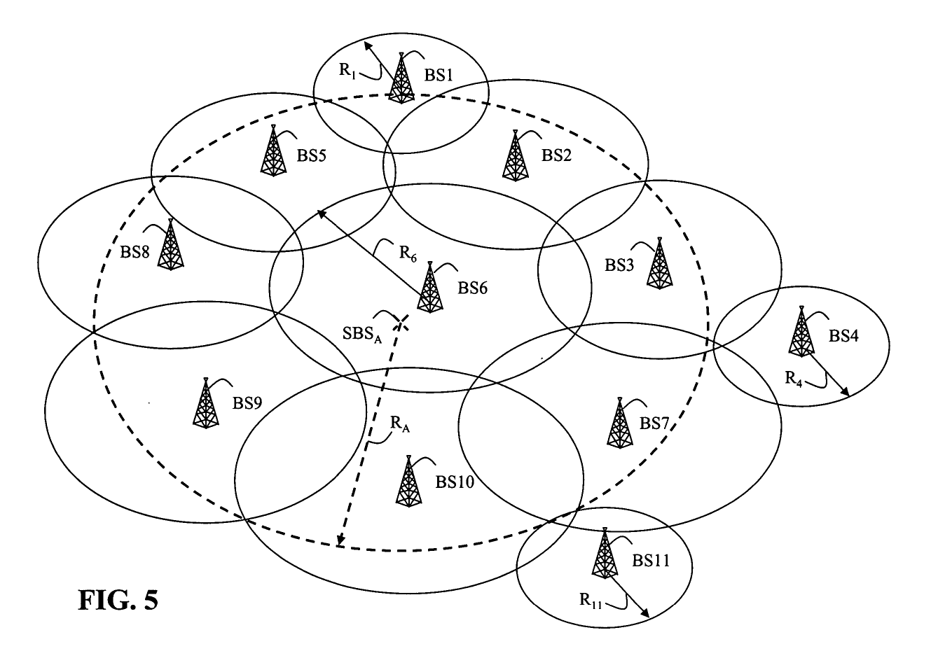

In one embodiment, as illustrated in FIGS. 4 and 5, the database 80 may be organized so that the database 80 contains information for the coverage areas for each base station BS1-B11 that operates under a particular wireless communication protocol. In an effort to reduce the size of the database, as shown in FIGS. 5 and 6, a preferred embodiment includes a database 80 that has one or more super base station SBSA coverage areas that is circular in shape. A super base station coverage area, circular in shape, would represent a combined coverage area from a plurality of cellular base stations. For instance, in FIG. 5, a super base station SBSA coverage area could represent a combined coverage area from cellular base stations BS1-BS3 and BS5-BS10.

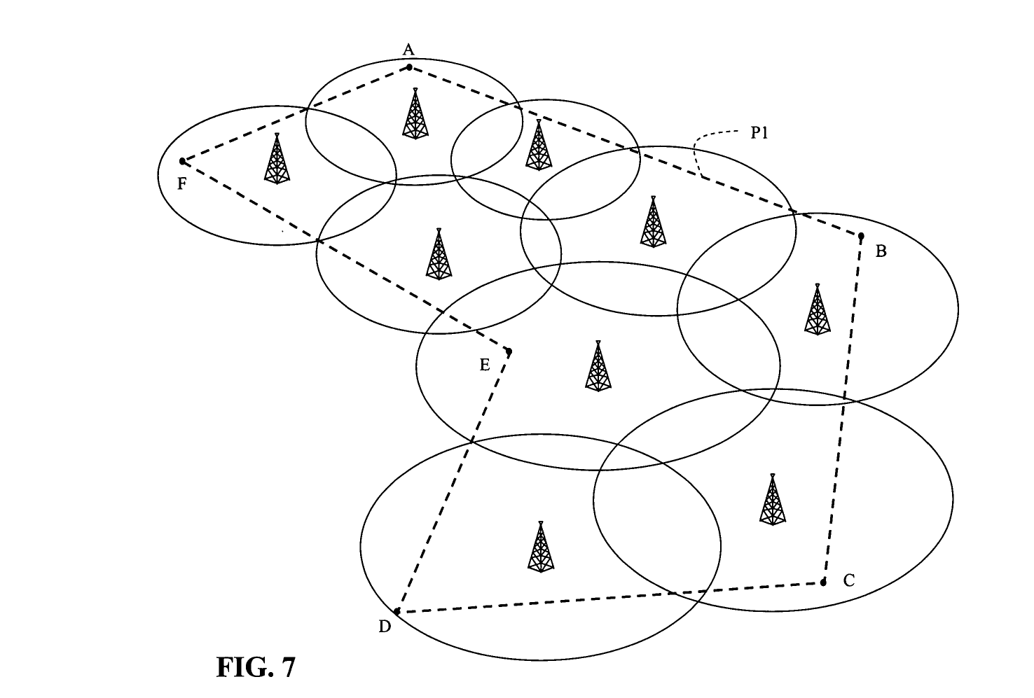

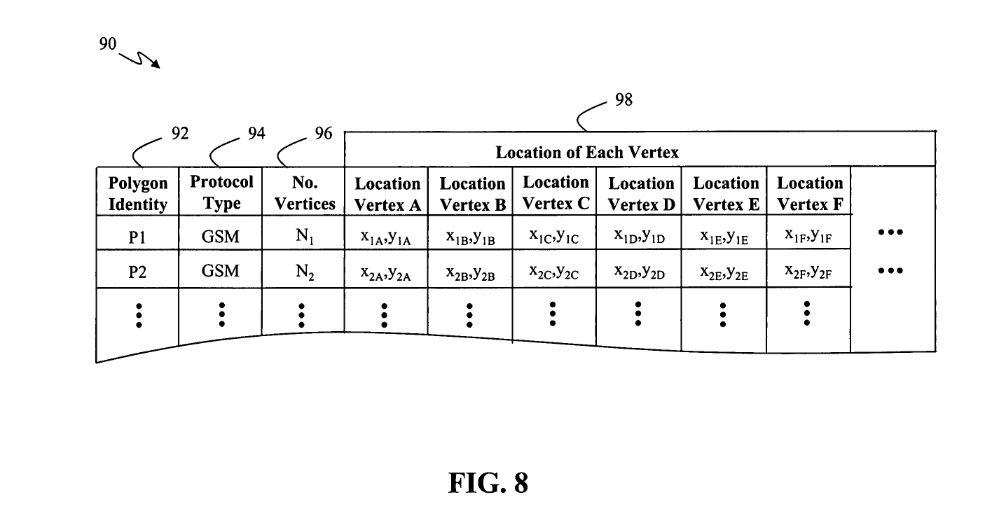

In another embodiment of the present invention, as illustrated in FIGS. 7 and 8, a database 90 could contain information regarding one or more super base station coverage areas that are irregular in shape. The super base station coverage area would represent a combined coverage area from a plurality of cellular base stations. For instance, in FIG. 8, the database 90 could contain a separate list of coverage bounding polygons P1, P2, etc. for situations where overlapping base stations provide a non-circular coverage area. There are different ways to set up a database but, in one embodiment, the database 90 may provide a polygon identity field 92 that may distinguish one polygon coverage area from another, a wireless protocol type field 94 that may identify the type of protocol of the coverage area, a number of vertices field 96 that may identify the number of vertices in the coverage area, and a location for each vertex field 98 that identifies the coordinates (longitude and latitude) of each vertex in the polygon.

An irregular shaped coverage area could be the result of several base stations positioned along a highway. This is further illustrated in FIG. 7 by the polygon P1. For each polygon in the database, the database should contain at least the number of vertices in the polygon (field 96 in database 90) and the location of each vertex in the polygon such as a latitude and longitude (field 98 in database 90). In this case, when analyzing whether a particular point is within the polygon coverage area P1, it would be assumed that the polygon coverage area be constructed by straight lines between vertices and connecting the last vertex in the list with the first vertex in the list. Further, in such an analysis, the polygon must be a single, closed polygon, with no segments connecting vertices crossing. The coverage area could then be defined as the area bounded by the polygon, assuming the list is in clock-wise order. For instance, if someone were walking along the edge of the polygon, going from vertex A to vertex B to vertex C, etc. in the list of vertices defining the polygon, then the area on the right hand side of each defined straight line would be inside the polygon, while the area on the left hand side would be outside the polygon. If a determination is made that a particular location of the vehicle 26 is on the right hand side of each defined straight line, then the device would be within the polygon coverage area. This type of right-hand rule relationship for polygons could be used in analyzing whether a particular location of the wireless communication device 22 is within the polygon coverage area or outside the polygon coverage area.

Referring back to FIG. 3, the process continues to decision block 108 where the controller 56 in the head unit 50 determines whether the vehicle 26 is within the range of a first wireless communication protocol. This may be accomplished by having the controller 56 compare the location of the wireless communication device 22 (obtained in process block 104) to the database 80, 90 of information regarding the geographic coverage areas (accessed in process block 106) as mentioned above. Moreover, in a further embodiment, the controller 56 may further use position and the direction of the vehicle 26 and attempt to determine whether continuous coverage will exist for a period of time. This avoids any ping-pong effects that may occur if there are small pockets of coverage areas. If the controller 56 determines that the vehicle 26 is within the range of a first wireless communication protocol, then the process continues to block 110 where the controller 56 sends a message to the Telematics unit 40, via the vehicle bus 60, to switch the wireless communication link from the second network access device 44 to the first network access device 42. This will redirect the communication from the second network access device 44 to the first network access device 42. If the controller 56 determines that the vehicle 26 is not within the range of a first wireless communication protocol, then the process continues to back to process blocks 104 and 106.

What has been described is a device and method in a wireless communication device having more than one transceiver operating under different protocol technologies. The device and method is advantageous to a situation where a controller in the device needs to redirect a wireless communication link from a secondary network access device to a preferred network access device. This redirection can be done without turning on both network access devices simultaneously. The present invention utilizes a database of service coverage locations for a preferred protocol technology in conjunction with its current geographic position to determine if a call should be redirected to the preferred technology transceiver. If the current location of the vehicle is not within the preferred service coverage area, then the secondary network access device can be continuously used. This is especially important for systems with two network access devices that cannot be turned on at the same time. Moreover, the device and method of the present invention saves power by preventing an attempted call or message through a transceiver that operates under a protocol that is not supported in a particular geographic area. The above description of the present invention is intended to be exemplary only and is not intended to limit the scope of any patent issuing from this application. The present invention is intended to be limited only by the scope and spirit of the following claims.

1. A wireless communication device in a vehicle for maintaining a communication link according to either a first wireless communication protocol or a second wireless communication protocol, the device comprising:
a first network access device that operates according to the first wireless communication protocol;
a second network access device that operates according to the second wireless communication protocol;
a positioning unit for determining a location of the vehicle;
a memory that stores a database of geographic coverage areas for maintaining the communication link according to the first wireless communication protocol; and
a controller that switches a communication link from operating according to the second wireless communication protocol to operating according to the first wireless communication protocol when the location of the vehicle falls within the geographic coverage area of the first wireless communication protocol.

2. The wireless communication device in claim 1, wherein the first wireless communication protocol is a Global System for Mobile Communications (GSM) protocol.

3. The wireless communication device in claim 2, wherein the second wireless communication protocol is an Advanced Mobile Phone System (AMPS) protocol.

4. The wireless communication device in claim 1, wherein the geographic coverage areas in the database stored in the memory are capable of being updated by a remote service center.

5. The wireless communication device in claim 1, wherein the positioning unit comprises a global positioning system (GPS) receiver.

6. The wireless communication device in claim 1, wherein the controller further determines whether the geographic coverage areas for maintaining the communication link according to the first wireless communication protocol will be continuous prior to switching the communication link to the first wireless communication protocol.

7. The wireless communication device in claim 1, wherein the first network access device and the second network access device are located within a Telematics unit and the positioning unit, the memory, and the controller are located within a head unit, the Telematics unit and head unit capable of communicating with each other through a vehicle bus.

8. The wireless communication device in claim 7, wherein the controller switches a communication link from operating according to the second wireless communication protocol to operating according to the first wireless communication protocol by sending a message over the vehicle bus to the Telematics unit.

9. A wireless communication device in a vehicle, the wireless communication device comprising:
a first and second transceiver, the first transceiver operating according to a first wireless communication protocol and the second transceiver operating according to a second wireless communication protocol;
a positioning unit for determining a location of the wireless communication device;
a memory that stores information regarding the geographic coverage areas for communicating with remote base stations that operate according to the first wireless communication protocols; and
a means for switching from the second transceiver to the first transceiver when the location of the wireless communication device from the positioning unit is within the geographic coverage areas for communicating with remote base stations that operate according to the first wireless communication protocol.

10. The wireless communication device in claim 9, wherein the first wireless communication protocol is a Global System for Mobile Communications (GSM) protocol.

11. The wireless communication device in claim 9, wherein the second wireless communication protocol is an Advanced Mobile Phone System (AMPS) protocol.

12. The wireless communication device in claim 9, wherein the geographic coverage areas in the database stored in the memory are capable of being updated by a remote service center.

13. The wireless communication device in claim 9, wherein the positioning unit comprises a global positioning system (GPS) receiver.

14. The wireless communication device in claim 9 further comprising a means for determining whether the geographic coverage areas for maintaining the communication link according to the first wireless communication protocol will be continuous prior to switching the communication link to the first wireless communication protocol.

15. The wireless communication device in claim 9, wherein the first transceiver and the second transceiver are located within a Telematics unit and the positioning unit, the memory, and the controller are located within a head unit, the Telematics unit and head unit capable of communicating with each other through a vehicle bus.

16. The wireless communication device in claim 15, wherein the means for switching from the second transceiver to the first transceiver includes sending a message over the vehicle bus from the head unit to the Telematics unit.

17. A method in a wireless communication device of a vehicle, the wireless communication device having a first network access device and a second network access device, the first network access device operating according to a first wireless communication protocol, the second network access device operating according to a second wireless communication protocol, the method comprising the steps of:
determining whether the wireless communication device is communicating through the second network access device;
determining the location of the vehicle when it is determined that the wireless communication device is communicating through the second network access device;
accessing a memory in the wireless communication device to obtain information regarding geographic coverage areas for communicating with remote base stations that operate according to the first wireless communication protocol; and
redirecting a communication from the second network access device to the first network access device based on the location of the vehicle and based on the information regarding the geographic coverage areas for communicating with the remote base stations that operate according to the first wireless communication protocol.

18. The method in claim 17, wherein the memory in the wireless communication device is capable of being changed by a remote service center with revised information regarding the geographic coverage areas for communicating with remote base stations that operate according to the first wireless communication protocol.

19. The method in claim 17, wherein the first communication protocol is a Global System for Mobile Communications (GSM) protocol and the second communication protocol is an Advanced Mobile Phone System (AMPS) protocol.

20. The method in claim 17 further comprising the step of determining whether the location of the vehicle should be continuous for a period of time within the geographic coverage areas for communicating with remote base stations that operate according to the first wireless communication protocol before redirecting the communication from the second network access device to the first network access device.
